(19) United States
(12) Patent Application Publication
(10) Pub. No.: US 2023/0195884 A1
(43) Pub. Date: Jun. 22, 2023

(54) METHOD FOR SECURING A SYSTEM CALL, METHOD FOR IMPLEMENTING AN ASSOCIATED SECURITY POLICY AND DEVICES FOR CARRYING OUT SUCH METHODS

(71) Applicant: Orange, Issy-les-Moulineaux (FR)

(72) Inventors: Maxime Belair, CHÂTILLON CEDEX (FR); Sylvie Laniepce, CHÂTILLON CEDEX (FR)

(21) Appl. No.: 17/999,532

(22) PCT Filed: May 18, 2021
(86) PCT No.: PCT/FR2021/050860

§ 371 Date: Nov. 21, 2022

(30) Foreign Application Priority Data
May 20, 2020 (FR) F2005153

(51) Int. Cl. G06F 21/53; G06F 21/62; G06F 21/55

(52) U.S. Cl. CPC G06F 21/53; G06F 21/554; G06F 21/6218; G06F 2221/2141

(57) ABSTRACT

Methods for securing a system call and methods for implementing an associated security policy are described, along with devices for carrying out such methods. The securing method secures at least one system call triggered by a current process of a user space of a software system. This method is implemented by a kernel of the software system before executing at least one operation triggered by the at least one system call and includes obtaining at least one namespace of the kernel, the namespace being dedicated to the security management associated with the current process, executing a security policy associated with the operation and recorded in an area of the kernel defined in the namespace, obtaining at least one ancestor namespace of the current process dedicated to the security management, executing a security policy associated with the operation and recorded in an area of the kernel defined in the ancestor namespace, and processing the system call according to a result of these executions.

The invention relates to the general field of the securing of computer programs and more specifically that of the securing of system calls of a kernel by the processes of a software stack executing in a user space.

In this document, the protection of a system call more specifically consists in protecting accesses (reading/creation/modification/deletion, etc.) to the sensitive resources of the kernel (inodes, files, etc.) which can be triggered in the code of the system call from the user space, for example to manage sensitive operations of opening a file, sending a packet, creating an “inode”, etc.

More precisely, this protection consists in checking, just before these sensitive resources are accessed, that the access can be validated.

The invention has a preferred but non-limiting application in Linux-type environments.

In the prior art, the LSM (Linux Security Module) infrastructure is the standard means of improving the security of a software stack in a Linux environment, and in particular the access to the sensitive resources of the kernel. It makes it possible to put in place, in the form of Linux security modules, additional security policies for Discretionary Access Control (DAC) which are in particular:
Mandatory Access Control (MAC), in particular proposed by the AppArmor module;
Role-Based Access Control (RBAC), in particular proposed by the SELinux module; and
integrity control, in particular proposed by the IMA module.

In a manner known to those skilled in the art, these policies are applied at kernel level in “hooks” (primitives allowing the LSM modules to execute arbitrary “bits of code” during sensitive operations (opening a file, receiving a network packet, etc.)

Today there are LSM modules that make it possible to define and apply different security policies for different software stacks in the user space. However, these modules are difficult to maintain since they incorporate both the security policy itself and its implementation. In addition, these LSM modules apply security policies by process or by process hierarchy. In this case, it is possible that an elevation of privilege may occur. For example, a process can have higher rights than those of the process that requested its creation since it inherits the rights of the process that created it. The latter is not in the process hierarchy of the one that requested the creation when the process creation is done through another process with which the requesting process has no parental link. In this case, the policies of the requesting process are not applied to the created process, which is undesirable from the point of view of safety.

One of the aims of the invention is to remedy inadequacies/drawbacks of the prior art and/or make improvements.

More precisely, and according to a first aspect, the invention relates to a method for securing at least one system call triggered by a current process of a user space of a software system. This method is implemented by a kernel of the software system before executing at least one operation triggered by said at least one system call and includes:
a step of obtaining at least one namespace of the kernel dedicated to the security management associated with the current process;
a step for determining whether or not said at least one naming space includes a security policy associated with said operation and stored in a kernel area;
a step of executing the security policy; and
a step of handling the system call as a function of a result of this execution.

Thus, and in general, the invention makes provision for a mechanism allowing a process or set of processes of the user space to define its own security policies to be implemented by the kernel.

The invention finds a preferred application in the Linux environment but can be applied to any operating system offering a mechanism for isolating resources by namespace. Specifically, the invention makes provision for defining a new namespace dedicated to security management and defining security policies in these namespaces.

Unlike the LSM modules of the prior art, this security mechanism makes provision for associating security policies with a namespace of the kernel instead of incorporating the policy into the LSM module itself. This feature very advantageously makes it possible to benefit from all the mechanisms of management of the namespaces of the kernel.

According to a second aspect, the invention relates to a method for putting in place a security policy, this method being implemented by a software stack of a user space of a software system to secure at least one system call able to be triggered by a process of the software stack. This method includes a step of loading the security policy into an area of the kernel of said system, said security policy being associated with a namespace dedicated to the security management associated with an operation able to be triggered by said at least one system call of this process.

Thus, and very advantageously, the security policy can be loaded by the software stack into the kernel, including when it does not enjoy administrator privileges. This feature is particularly advantageous since LSM modules of the prior art require the policies to be put in place by an entity of the user space having administrator rights.

The invention also relates to a device including a user space and a kernel, the user space including at least one process able to trigger at least one system call of the kernel. This device is characterized in that:
the kernel includes a security control infrastructure and a security module, this infrastructure being configured to execute the security module before executing at least one operation triggered by the system call;
said security module being configured to:
obtain at least one namespace of the kernel dedicated to the security management associated with the process;
determine whether or not said at least one namespace includes a security policy associated with the operation and stored in an area of said kernel; and
execute said at least one security policy.

In an embodiment, the method (or device) for securing at least one system call determines whether or not the namespace of the current process includes at least one ancestor. If such is the case, the method (or device) implements for each of these ancestor namespaces a handling identical to that implemented for the namespace associated with the current process.

More precisely, in this embodiment, the method includes:
a step of obtaining the namespace or spaces dedicated to security management and ancestor(s) of the namespace of the current process;
a step for determining whether or not this namespace or namespaces include a security policy associated with the operation and stored in an area of the kernel;
a step of execution of this security policy; and
a step of handling the system call as a function of a result of this execution.

In an embodiment of the method for putting in place a proposed security policy, the software stack is a container and the loading of the security policy is defined by an instruction of a configuration file of the container. This configuration file can for example be in accordance with the specifications defined by the OCI (Open Container Initiative) or a file of Dockerfile type. It is recalled that a file of Dockerfile type is a text file that includes the commands needed to generate the image of a container.

Particularly advantageously, the security policies can be loaded by the software stack or by the container “hot”, i.e. during the execution of the container.

Thus, the operation triggered by a system call of the current process causes the execution of the security policy or policies associated with this operation in the namespace of this process, but also in the ancestor namespaces of the namespace of this process, if any exist.

Thus, and in particular, the processes of a container inherit security policies defined in the ancestor namespaces. The process to which the security policy is applied cannot have rights higher than those defined by the security policy or policies defined in the ancestor namespaces.

In this sense, it can be said that the proposed method makes it possible to stack personalized security policies for the processes of a namespace.

In a particular embodiment, the software stack or the container of the user space builds an executable code which contains its own security policies applicable to particular operations (opening of a file, receiving of a network packet, etc.) This code can be loaded on execution (i.e. dynamically) through a system interface to the kernel. It is then executed by the kernel when these operations (or events) occur for a process belonging to this container. Since this code is not necessarily executed by a trusted process (potentially malicious), it must not be able to interfere with the rest of the system or the kernel. Thus, the security policies are only applied if they do indeed refer to the container from which the policy applicable to the event originated.

Advantageously, since it is possible that a software stack is compromised, a security policy cannot be disabled or modified from the user space, in particular by a software stack or a container belonging to a namespace for which this policy was defined.

In a particular embodiment, the proposed securing method includes a step of deleting at least one security policy by the kernel if this security policy is not contained in a namespace dedicated to the security associated with at least one active process of the user space.

In a particular embodiment, the proposed securing method includes a step of determining whether or not the system call is associated with a sensitive operation and the securing method is only implemented for sensitive operations (opening of a file, sending of a packet, execution of a function, etc.) This determination can in particular be carried out by the system call manager of the kernel.

In an embodiment of the proposed securing method, the handling step consists in executing the operation if the result of the execution of said at least one security policy does not detect any security problem and in triggering a security action if the result of the execution of said at least one security policy detects at least one security problem.

In an embodiment of the proposed securing method, the security action includes the destruction of the current process.

In an embodiment of the proposed securing method, a security policy is a file in binary language obtained by compilation of a program in eBPF (Extended Berkeley Packet Filter) language.

In a known manner, this language is deliberately limited in terms of functionality (no loops, no pointer arithmetic, no direct access to the kernel structures, etc.) but has strong security properties such that it is incapable of attacking the rest of the system.

This feature advantageously makes it possible to prevent critical attacks, for example to retrieve information, modify the integrity or availability of the rest of the system.

The proposed technique thus allows a software stack to introduce security policies without compromising the security of the system. It allows in particular the application of more stringent policies after the set-up of the software stack to subsequently block behavior that would only be acceptable at set-up.

Since the possibilities offered by the eBPF language are limited, in an embodiment of the proposed method for putting in place a security policy, at least one security policy calls at least one helper function external to this policy and loaded into a dedicated area of the kernel by an entity of the user space enjoying administrator rights.

These helper functions may be loaded “hot”, i.e. during the execution of the kernel. They may be called by an eBPF security policy to perform critical handling such as accesses to the kernel structures for the eBPF code. These helper functions can only be written by an entity enjoying administrator rights and are not subject to the limitations related to the eBPF checker.

By handing over the critical accesses and complex handling to the helper functions, this particular embodiment makes it possible for the containers to put in place policies developed without compromising the security of the system and with low excess performance costs.

In a particular embodiment, at least one helper function is a dynamic function executable independently of its position, this dynamic function being called by a static helper function compiled with the kernel and called by the security policy. For more information on the concept of position independent code, those skilled in the art may refer to the document available at the address https://fr.qwe.wiki/wiki/Position-independent_code.

In a particular embodiment, the proposed method for putting in place a security policy includes a step of analyzing a log file including at least one result of execution of a security policy executed by a securing method as mentioned above.

The proposed securing method and method for putting in place a security policy are implemented by computer programs.

Consequently, the invention also relates to a computer program on a recording medium, this program being able to be implemented in a device or more generally in a computer. This program includes instructions allowing the implementation of a method as described above.

This program can use any programming language, and be in the form of source code, object code or intermediate code between source code and object code, such as in a partially compiled form, or in any other desirable form.

The invention also relates to an information medium or a recording medium readable by a computer, and including instructions of a computer program as mentioned above.

The information medium or recording medium can be any entity or device capable of storing the programs. For example the media may include a storage means, such as a ROM, for example a CD-ROM or a microelectronic circuit ROM, or a magnetic recording means, for example a diskette (floppy disk) or a hard disk, or a flash memory.

Moreover, the information or recording medium can be a transmissible medium such as an electrical or optical signal, which can be conveyed via an electrical or optical cable, by radio link, by wireless optical link or by other means.

The proposed computer program can in particular be downloaded over a network of Internet type.

Alternatively, the information or recording medium can be an integrated circuit into which a program is incorporated, the circuit being suitable for executing or being used in the execution of one of the methods as described previously.

Other features and advantages of this invention will become apparent from the description given below, with reference to the appended drawings which illustrate an exemplary embodiment thereof without any limitation. In the figures:

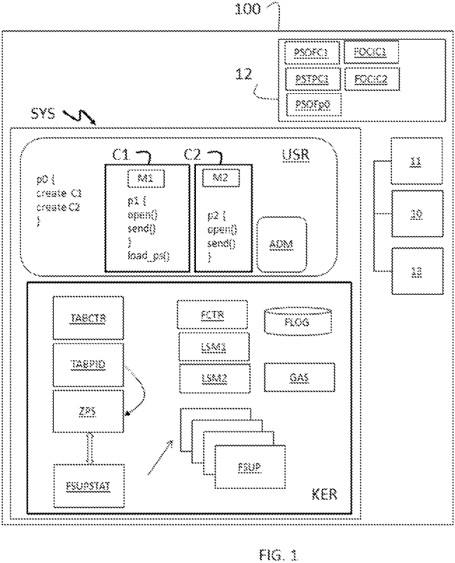

FIG. 1 shows a device in accordance with a particular embodiment and the main steps of a method for putting in place a security policy in accordance with a particular embodiment;

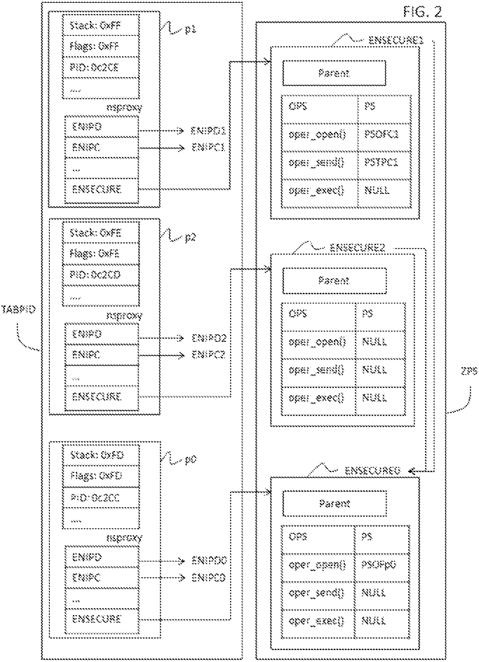

FIG. 2 shows a process table that can be used in a particular embodiment;

FIG. 3 shows a control table that can be used in a particular embodiment;

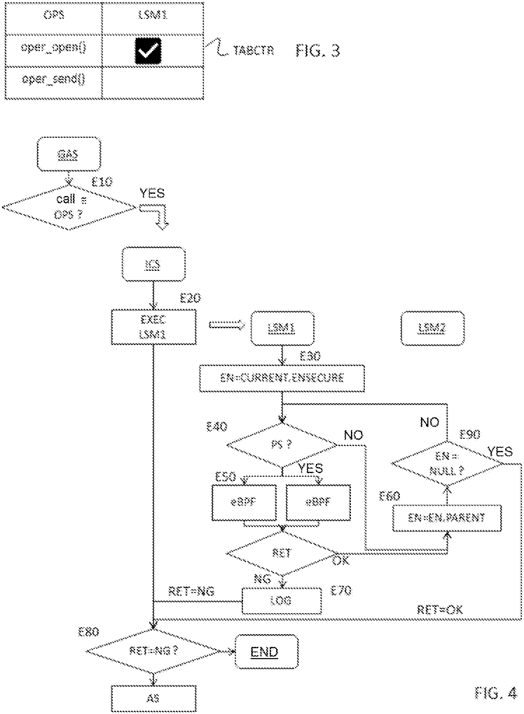

FIG. 4 shows in the form of a flow chart the main steps of a securing method in accordance with a particular embodiment.

FIG. 1 shows a device 100 in accordance with the invention. In the exemplary embodiment described here, this device 100 has the hardware architecture of a computer. It includes in particular a processor 10, a random access memory of RAM type 11, a read-only memory of ROM type 12, and communication means 13.

This device includes a software system SYS, this system including a kernel or operating system KER, and a user space USR. In the embodiment described here, the operating system KER is of Linux ® type.

In the embodiment described here, the user space USR includes a process p0(), two software stacks of container C1, C2 type and an administration tool ADM. The process p0() and the software stacks C1, C2 are associated with user level rights and the administration tool ADM with admin level rights.

In the exemplary embodiment described here, the software stacks C1, C2 of the user space USR are containers, each including a set of processes isolated from the rest of the software system SYS.

In this example, the creation of the containers C1 and C2 is requested by the process p0().

It is recalled that the processes of the user space USR can be isolated owing to the known mechanism of namespaces. In a known manner, the operating system Linux makes provision in the prior art for several namespaces (for example Network, IPC, PID, User)... which can be used to isolate processes in a mechanism in which sets of processes are defined, such that the processes of a given set cannot see the resources used by another set of processes .

In the example of FIG. 1:
the process p0 is respectively associated with namespaces ENNETWORK0 (for the Network space), ENIPC0 (for IPC), ENPID0 (for PID), ENUser0 (for User) ... ;
the processes of the container C1, in this case the processes p1(), are associated with different namespaces ENNETWORK1, ENIPC1, ENIPD1, ENUser1; and
the processes of the container C2, in this case the process p2(), are associated with different namespaces ENNETWORK2, ENIPC2, ENIPD2, ENUser2.

Certain processes of the system SYS may use system functions of the kernel KER. The kernel KER includes a system call manager GAS in which these system calls are implemented.

The invention makes provision for a security management mechanism to secure the system calls triggering sensitive operations within the Linux Security Modules (LSM).

In the embodiment described here, it is considered that the operations oper_open() of opening a file, oper_send() of sending function execution packets and oper_exec() of executing functions are sensitive operations.

In the example of FIG. 1 the process p1 of the container C1 and the process p2 of the container C2 call:
the file-opening system call open() which when executed generates the sensitive operation oper_open(); and
the packet-sending system call send() which when executed generates the sensitive operation oper_send().

In the example of FIG. 1, the process p0 does not use open system calls open() send(), exec().

In the embodiment described here, the invention makes provision for using a new namespace ENSECURE dedicated to security management.

For example, the process p0 is associated with the security management namespace ENSECURE0, the container C1 is associated with the security management namespace ENSECURE1 and the container C2 is associated with the namespace ENSECURE2.

FIG. 2 shows in detail a table TABPID of the processes p0, p1 and p2 stored in the memory of the kernel KER. In the kernel KER, a process is composed of a structure including several fields making it possible to manage the lifecycle of the process such as its process identifier PID, its flags, its stack...

In the kernel space, the data structure corresponding to the current process can be retrieved using the instruction “current” (see step E30, FIG. 4).

This structure also includes an nsproxy field which includes pointers to the namespaces. In accordance with this particular embodiment, this nsproxy field includes a pointer ENSECURE to the namespace dedicated to the security management associated with the process. This namespace defines a data structure which in particular comprises the security policy defined in eBPF language. In the embodiment described here, these structures are stored in a security policy area ZPS of the kernel KER.

The namespace ENSECURE of a process includes a link to the namespace ENSECURE of the parent of the namespace of this process. In the example described here, ENSECURE1 and ENSECURE2 respectively associated with the containers C1 and C2 point to the namespace ENSECURE0 of the process p0.

The namespaces ENSECURE thus form a tree.

In a manner known to those skilled in the art a process can change namespace to join the namespace of one of its child processes, for example using the command unshare().

From the user space USR, it is possible to access the identifier of a namespace but it is not possible to modify its structure. This feature advantageously makes it possible to prevent any modification or disabling of a security policy by a container.

In the exemplary embodiment described here, it is assumed that the process p0() has defined a security policy PSOFp0 to secure the calls to the sensitive operation of opening the file oper_open(). It is assumed that it has not defined any security policy to secure the calls to the sensitive operation of sending a packet over the network oper_send().

In the embodiment described here, the processes of a container inherit the security policies defined by all its namespace ENSECURE ancestors.

In the exemplary embodiment described here, it is assumed that the container C1 has defined its own security policy PSOFC1 to secure the calls by its processes, in this case p1(), to the sensitive operation of opening a file oper_open(), in addition to the policy PSOFp0 defined by the process p0().

It is assumed that the container C1 has defined a security policy PSTPC1 to secure the calls by its processes, in this case p1(), to the sensitive operation of sending a packet oper_send().

It is assumed that the container C2 has not defined any security policy of its own. The process p2() of this container inherits the security policy PSOFp0 defined by the process p0() to secure its calls to the sensitive operation of opening a file. But it does not define any security function to check the sensitive operation of sending a packet.

In the embodiment described here, each of the security policies PSOFp0, PSOFC1, PSTPC1 is defined by a software function eBPF language compiled in binary. These security policies are stored in the read-only memory 12 of the device 100 and intended to be loaded into the security policy area ZPS of the kernel KER.

This loading (step F10) can be done in different ways.

In the embodiment described here, the read-only memory 12 includes a configuration of OCI (Open Container Initiative) type for each container, namely a configuration file FOCIC1 for the container C1 and a configuration file FOCIC2 for the container C2.

In a known manner, the configuration OCI of a container is specified under the name config.json and details the features of the container to be created. This configuration file in particular specifies the files that the container must contain, its system interfaces, its namespaces, etc.

In the embodiment described here, the configuration file OCI of a container includes instructions for the container to load its security policies into the security policy area ZPS of the kernel KER.

When a container is created, for example C1, the security policies PSOFC1 and PCTPC1 of the container C1 are copied from the read-only memory 12 into a memory M1 of the container C1. Once the container C1 is constructed, it is executed and on execution, the security policies are transferred from the memory M1, into the area ZPS of the kernel.

The manual writing of OCI configuration files can however prove complex, and in another embodiment of the invention, the loading of the security policy of a container into the kernel KER is defined by an instruction of a higher-level container construction method, for example the Dockerfile method.

Moreover, the loading of a container’s own security policy into the memory of the kernel can be done at any time of the lifecycle of the container, not only during its set-up. In the embodiment described here, the code of the container C1 also includes instructions load_ps() making it possible to load a security policy in the form of an eBPF file compiled in binary form into the ZPS area of security policies of the kernel KER. This embodiment in particular makes it possible to load a new security policy which will be applied after the starting of the container C1. This function load_ps() consists in opening the file eBPF contained in the read-only memory 12 and in copying it to an interface with the kernel KER.

In the embodiment described here, the kernel KER includes a security control infrastructure ICS for managing Linux Security Modules, a Linux Security Modules LSM1 in accordance with the invention and another security module LSM2, for example, a SELinux module or an AppAmor module as mentioned previously.

In the exemplary embodiment described here, the kernel KER includes a check table TABCTR which defines, for each sensitive operation OPS (opening of a file, sending packets over a network, etc.) if the security module LSM1 will or will not check these sensitive operations. This table TABCTR is shown in FIG. 3.

In the example of checking described here, it is assumed that the security module LSM1 only wishes to check the sensitive operation of opening a file.

FIG. 4 shows in the form of a flow chart the main steps of a securing method in accordance with a particular embodiment. In the embodiment described here, this method is implemented by the system call management GAS, the security control infrastructure ICS (framework LSM) and by the security module LSM1.

In the exemplary embodiment described here, the system call manager GAS determines, during a step E10, whether or not a system call triggered by a process of the user space must perform a sensitive operation. If such is the case, it triggers the security control infrastructure ICS of the kernel KER.

If the infrastructure ICS determines that the sensitive operation OPS listed in the table TABCTR is supervised by the security module LSM1, the infrastructure ICS triggers the execution of the security module LSM1 during a step E20.

In the exemplary embodiment described here, if a process wishes to perform the sensitive operation of sending a packet (oper_send()) or executing a new process in the user space (oper_exec()) by calling the function exec(), as these sensitive operations are not checked by the security module LSM1, the result of the determining step is negative. These operations can however be checked by the security module LSM2, outside the scope of the invention, for example SELinux and an AppAmor module.

During a step E30, the security module LSM1 determines the namespace associated with the current process from which this call originated. To do this it uses the current process of the process table TABPID.

The security module LSM1 then executes a loop to execute the policies of the namespace of the current process related to this sensitive operation. In a particular embodiment, the security module LSM1 then executes a loop to execute the policies of its ancestor namespaces if any exist.

In a step E40 the security module LSM1 determines whether or not the current namespace has defined one or more security policies to check the validity of the sensitive operation.

If such is the case, the concerned security module LSM1 executes during a step E50 the security policy or policies defined in the namespace dedicated to the security management ENSECURE of the current process for this sensitive operation.

In this case, in a first iteration, the security policy PSOFC1 is executed. This security policy returns a result RET of this execution to the security module LSM1.

In the embodiment described here, a security policy, and in particular the security policy PSOFC1, returns a negative result RET if it detects a security problem (manifesting for example as malicious or abnormal behavior) and a positive result if it does not detect any security problem.

If this value RET remains positive, the security module determines, if any exist, the parent namespace of the namespace of the current process (step E60) and the loop repeats.

In this case, over the second iteration the security policy PSOFp0 of the namespace ENSECURE0 of the process p0 is executed.

If a security policy returns a negative result RET, the security module records this result in a log file FLOG of the kernel KER during a step E70 and sends this negative result RET to the security infrastructure ICS. This log file FLOG can be analyzed (step F30) by the administrator by means of the administration tool ADM.

When all the security policies of the entire namespace tree have been executed with a positive result RET, the security module LSM1 sends a positive result RET to the security infrastructure ICS (test E90).

In the embodiment described here, if the security infrastructure RET receives a positive result RET, it does not trigger any particular action and the system call is executed, unless an action is triggered by another security module LSM2, for example a SELinux module and an AppAmor module.

In the embodiment described here, if the security infrastructure RET receives a negative result RET , the control infrastructure ICS triggers a security action AS during a step E80. This action may consist in destroying the process from which the call originated and escalating an alert to the log file FLOG.

In the embodiment described here, when no process remains in a namespace dedicated to security management, this namespace is automatically destroyed by the kernel. This operation destroys the security policies associated with these namespaces.

For example, in the exemplary embodiment described here, as soon as the process p1 dies, there is no longer in the system SYS any process for which the namespace dedicated to security management is ENSECURE1 so the security policies PSOFC1 and PSTPC1 may be destroyed.

In the embodiment described here, if a security policy is not included in a namespace dedicated to the security associated with at least one active process of the user space, this security policy is deleted by the kernel.

In accordance with the invention, the security policies in compiled eBPF language may call functions of the kernel KER external to these policies, to implement critical operations which may not be directly implemented by the security policy in eBPF language itself. Such functions are known to those skilled in the art under the name of helper eBPF functions.

In a particular exemplary embodiment of the invention, such a helper function FSUP can be written by an administrator, for example in C language, then compiled as a conventional kernel module with GCC (GNU Compiler Collection).

In the embodiment described here, this executable code is converted to be able to be executed independently of its position according to the PIC (Position Independent Code) mechanism known to those skilled in the art.

These dynamic helper functions FSUP may be loaded (step F20) into a dedicated area of the kernel KER without interrupting the execution of the kernel.

Once loaded into the kernel, these dynamic helper functions FSUP can be called by the eBPF code of a security policy using a single static helper function FSUPSTAT.

1. A method for securing at least one system call triggered by a current process of a user space of a software system , said method being implemented by a kernel of said software system before executing at least one operation triggered by said at least one system call,said method including:
obtaining at least one namespace of the kernel dedicated to security management associated with said current process
executing a security policy defined in the namespace associated with said operation and stored in an area of said kernel;
obtaining at least one ancestor namespace of said current process, said ancestor namespace being dedicated to security management ;
executing a security policy defined in the ancestor namespace associated with said operation and stored in an area of said kernel; and
handling said system call as a function of a result of executing said security policies.

2. The method of claim 1, including determining whether or not said operation is a sensitive operation.

3. The method of claim 1, whereinhandling said system call comprises:
executing said operation if the result of the execution of said at least one security policy does not detect any security problem; and
triggering a security action if the result of the execution of at least one said security policy detects a security problem.

4. The method of claim 3, wherein said security action includes the destruction of said current process .

5. The method of claim 1, including deleting at least one said security policy by said kernel if said security policy is not contained in a namespace dedicated to the security associated with at least one active process of said user space (USR).

6. A method for putting in place a security policy, said method being implemented by a software stack of a user space of a software system for securing at least one system call able to be triggered by a process of said software stack, said method including loading said security policy into an area of a kernel of said system, said security policy being defined in a namespace of the kernel dedicated to security management associated with an operation able to be triggered by said at least one system call of said process, said namespace comprising a link to an ancestor namespace.

7. The method of claim 6, wherein said software stack is a container, said loading of said security policy being defined by an instruction of a configuration file of said container, said configuration file being in accordance with the specifications defined by the Open Container Initiative (OCI) or a file of Dockerfile type.

8. The method of claim 6, wherein said at least one security policy calls at least one helper function external to said policy and loaded into a dedicated area of the kernel by an entity of said user space having administrator rights.

9. The method of claim 8, wherein said at least one helper function is a dynamic function executable independently of its position, said dynamic function being called by a static helper function compiled with said kernel and called by said security policy.

10. The method of claim 6, including analyzing a log file including at least one result of execution of a security policy executed by a securing method comprising
obtaining at least one namespace of the kernel dedicated to security management associated with said current process;
executing a security policy defined in the namespace associated with said operation and stored in an area of said kernel;
obtaining at least one ancestor namespace of said current process, said ancestor namespace being dedicated to security management;
executing a security policy defined in the ancestor namespace associated with said operation and stored in an area of said kernel; and
handling said system call as a function of a result of executing said security policies.

11. The method of claim 1, wherein said at least one security policy is a file in binary language obtained by compilation of a program in eBPF language.

12. A device comprising:
a user space; and
a kernel (KER), the user space including at least one process able to trigger at least one system call of said kernel, said kernel including:
a security control infrastructure; and
a security module, said infrastructure being configured to execute said security module before executing at least one operation triggered by said at least one system call, said security module (LSM1) being configured to:
obtain at least one namespace of the kernel dedicated to the security management associated with said process ;
obtain at least one ancestor namespace of said current process, said ancestor namespace being dedicated to security management ;
execute a security policy defined in the namespace associated with said operation and stored in an area of said kernel (KER); and
execute a security policy defined in the ancestor namespace associated with said operation and stored in an area of said kernel.

13. The method of claim 6, wherein said at least one security policy is a file in binary language obtained by compilation of a program in eBPF language.
